(19) United States
(12) Patent Application Publication
(10) Pub. No.: US 2019/0158734 A1
(43) Pub. Date: May 23, 2019

(54) CAMERA SYSTEM

(71) Applicant: Charles Isgar, Scottsdale, AZ (US)

(72) Inventor: Charles Isgar, Scottsdale, AZ (US)

(21) Appl. No.: 15/996,356

(22) Filed: Jun. 1, 2018

Related U.S. Application Data
(60) Provisional application No. 62/588,049, filed on Nov. 17, 2017.

(51) Int. Cl. H04N 5/232; G06T 1/00; H04N 21/2187; H04N 5/77

(52) U.S. Cl. CPC H04N 5/23222; H04N 5/772; H04N 21/2187; G06T 1/0007

(57) ABSTRACT

A camera system is described that includes a video camera, a first memory, and a second memory. The video camera continuously stores live video stream to the first memory for a prescribed amount of time before overwriting the live video stream in the first memory. A capture command causes the video camera to transfer the pre-recorded live video stream to a second memory. The captured video clip saved to second memory is not overwritten, and can be shared or stored.

### CROSS REFERENCE TO RELATED APPLICATION[S]

This application claims priority to U.S. Provisional Patent Application entitled “CAMERA SYSTEM,” Ser. No. 62/588,049, filed Nov. 17, 2017, the disclosure of which is hereby incorporated entirely herein by reference.

### BACKGROUND OF THE INVENTION

### Technical Field

This invention relates to cameras, and specifically to a video camera that continuously sends a video stream to temporary memory. The video stream temporarily stored can be transferred to second memory within a specified amount of time.

### State of the Art

People enjoy using cameras to capture events around them. Still pictures and video pictures are commonly captured and sent to friends and family. Unplanned events may be inadvertently captured and may become important evidence of occurrences. Since unplanned events are, by definition, unplanned, it is difficult to capture them on camera.

Accordingly, what is needed is a camera that continuously records a video stream, where the video stream can be sent to long-term storage within a specified amount of time if a record of past events is desired.

### DISCLOSURE OF THE INVENTION

The disclosed invention relates to cameras, and specifically to a video camera that continuously sends a video stream to temporary memory. The video stream temporarily stored can be transferred to second memory within a specified amount of time.

Disclosed is a camera system that includes a video camera with a first memory, a second memory communicatively coupled to the video camera, and a mobile computing device communicatively coupled to the video camera. The video camera has an image sensor that sends a continuous stream of live video to the first memory. The first memory stores the live video stream for a predetermined amount of time, then overwrites the stored live video stream with new live video stream. Upon receiving a capture command, the video stream transfers the stored live video stream in the first memory to the second memory for long-term storage as a captured video clip. The captured video clip can be shared or saved, and includes a video record of events that occurred before the capture command was received. The mobile computing device has a camera app that can be used to control the video camera or distribute the captured video clip.

An embodiment includes a camera system comprising: a video camera having an image sensor and a first memory, wherein the image sensor continuously sends a live video stream to the first memory while in operation; and a second memory communicatively coupled to the video camera, wherein the video camera sends a captured video clip to the second memory in response to receiving a capture command.

Another embodiment includes a camera system comprising: a video camera having an image sensor, a first memory and a processor, wherein the image sensor continuously sends a live video stream to the first memory for storage as a captured video clip while in operation and continuously overwrites the captured video clip to maintain the captured video clip with a predetermined length of video; and a second memory communicatively coupled to the video camera, wherein the video camera sends the captured video clip to the second memory in response to receiving a capture command, wherein the captured video clip is the most recent video of the predetermined length of video.

Another embodiment includes a method of using a camera system, the method comprising: mounting a video camera of the camera system to a support object, the video camera having a first memory; storing live streaming video in the first memory to create a captured video clip having a predetermined video length; continuously overwriting the captured video clip to ensure that the captured video clip includes the most recent live streaming video extending back a predetermined time to form the predetermined video length; and transferring the captured video from the first memory to a second memory in response to receiving a capture command.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a simplified block diagram of a camera system according to an embodiment;

FIG. 2 is a perspective view of a video camera mounted to the shirt of a user according to an embodiment;

FIG. 3 is an alternative perspective view of a video camera mounted to the shirt of a user according to an embodiment;

FIG. 4 is a perspective view of a video camera mounted to the hat of a user according to an embodiment; and

FIG. 5 is a method of using a video camera system according to an embodiment.

### DETAILED DESCRIPTION OF EMBODIMENTS OF THE INVENTION

As discussed above, embodiments of the present invention relate to a video camera that continuously sends a video stream to temporary memory. The video stream temporarily stored can be transferred to second memory within a predetermined amount of time. The system allows a user to capture video without having to predict the future that something video-worthy will happen because the system is continuously streaming.

People enjoy taking pictures and videos of friends, family, and surroundings. It is hard, however, to capture unplanned events because they are, by definition, unplanned. It is also difficult to impossible to have enough memory to permanently store a continuous video stream. What is needed is a camera that can capture a video stream in temporary memory, and then provide a mechanism to save the temporarily-stored video stream to second memory within a predetermined amount of time. If the temporarily-stored video stream is not sent to second memory within the predetermined amount of time, it is overwritten with a new live video stream. The predetermined amount of time gives a user of the camera a chance to decide if they want to save part or all of the video stream in second memory. If an unplanned event occurs during the capture of the live video stream, the user has the predetermined amount of time to decide if they want to save the video of the unplanned event. If so, the user can transfer the temporarily-stored live video stream to second memory.

Disclosed is a camera system that includes a video camera and a first and a second memory. The video camera continuously saves a live video clip to the first memory, which is temporary storage. The first memory saves a predetermined length of live video, say 15, 30 or 60 seconds, for example, before it overwrites the saved live video clip with new live video. The camera system includes the second memory, which is a second memory. The second memory may be a phone, a tablet, a computing device, a cloud server, a social media platform server and the like. The camera system transfers the live video clip in the first memory to the second memory in response to receiving a capture command, and may do so without editing of the video. The camera sends the captured video clip from the first memory to the second memory in response to the capture command, and continues to record and overwrite live video to the first memory. The captured video clip stored in the second memory can be kept permanently, sent to friends and family, used as evidence, or whatever else a user of the camera system desires to do with the captured video clip.

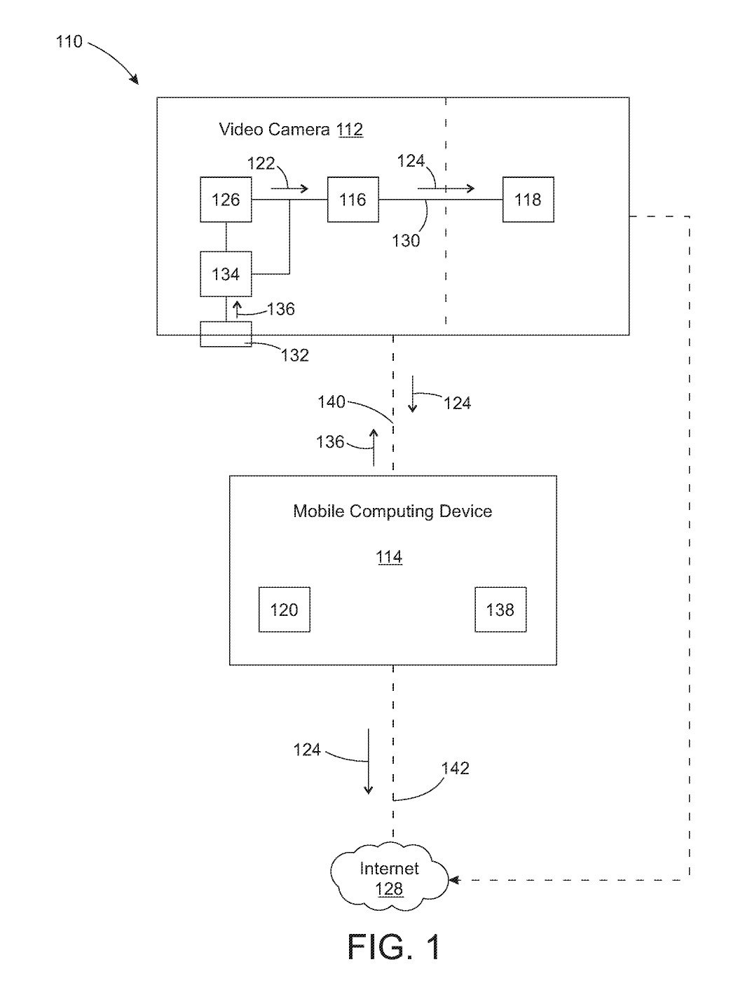

FIG. 1 shows a block diagram of an embodiment of a camera system 110. Camera system 110 includes a video camera 112, a memory 118, and a mobile computing device 114.

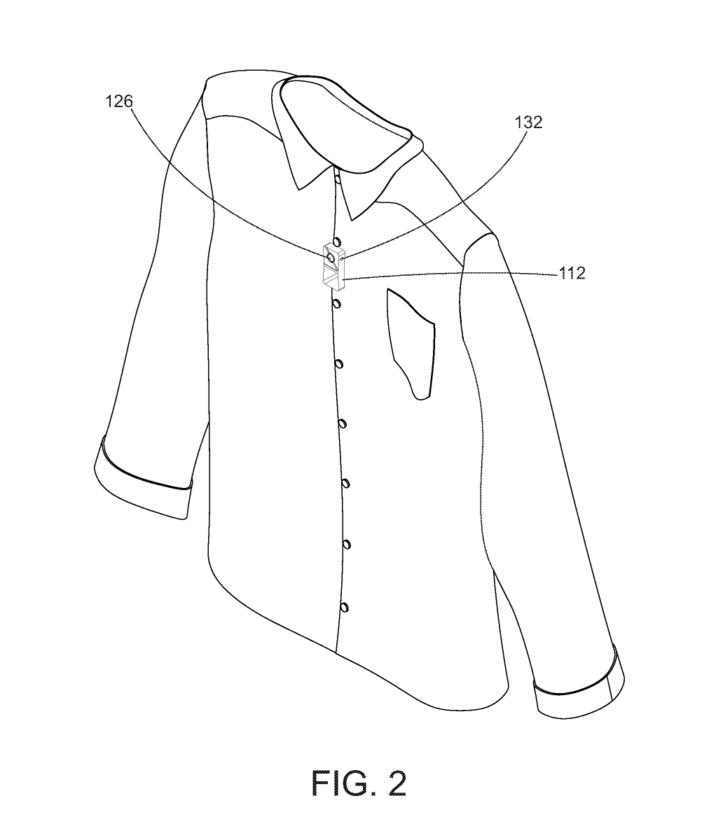

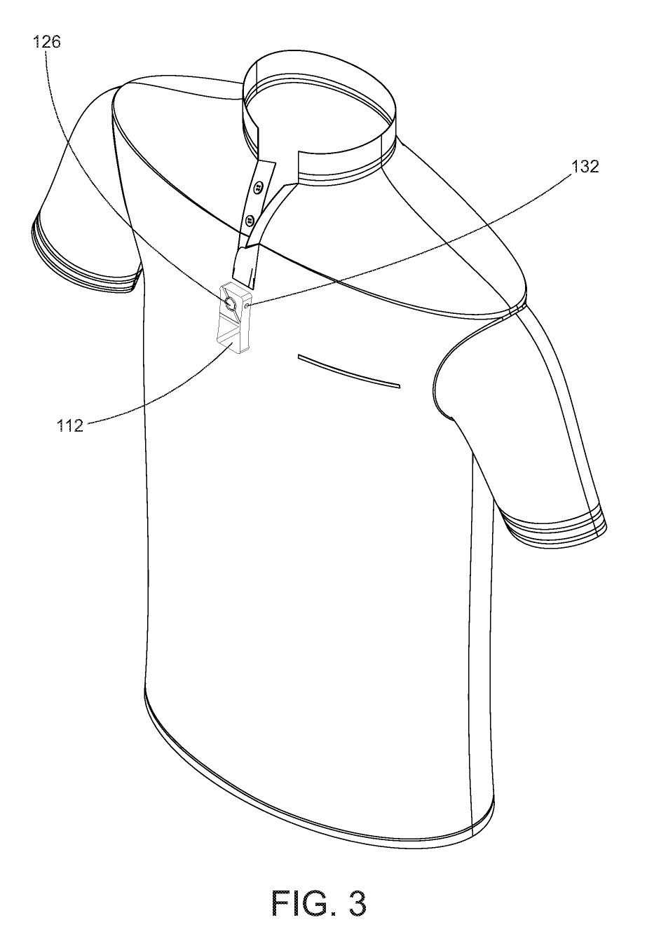

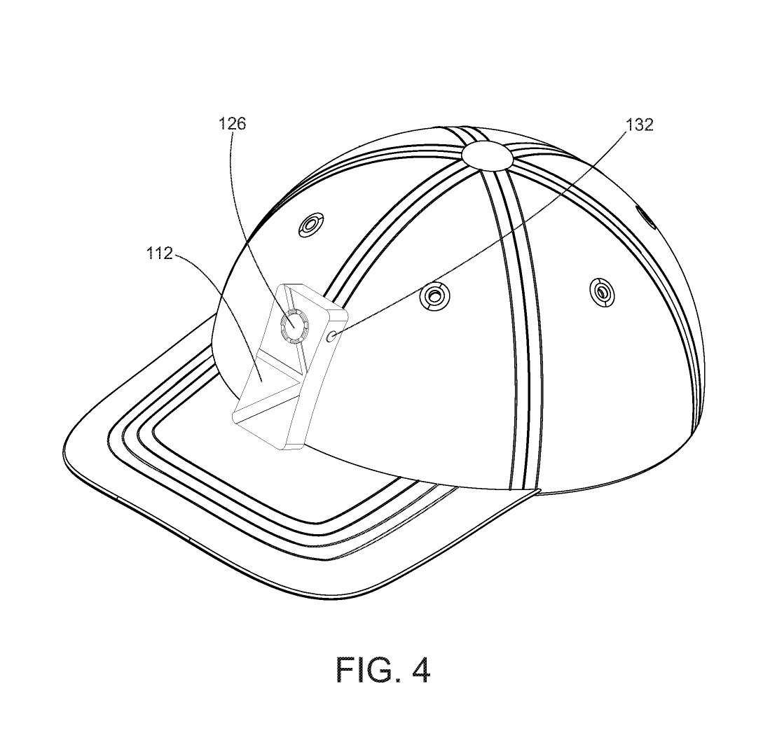

Video camera 112 can be any type of camera known today or in the future. In this embodiment, video camera 112 is a wearable camera that includes an image sensor 126, a processor 134, a first memory 116, and a capture button 132. Video camera 112 is contained in a housing that can be worn on the body, mounted in a vehicle, coupled to a wall or piece of furniture, or connected to any item so that camera 112 can capture a desired scene. For example, video camera 112 may be mounted to a shirt of a user, as shown in FIG. 2 and FIG. 3, or video camera 112 may be mounted to a hat of a user, as shown in FIG. 4.

Image sensor 126 is any type of image sensor, monochrome or color, that captures a still or video image capture using any visible or non-visible wavelength or wavelengths. In this embodiment, image sensor 126 continuously sends a live video stream 122 to memory 116. Memory 116 saves a first predetermined length of time of live video stream 122, before overwriting live video stream 122 with new video. In this embodiment, the first predetermined amount of time may be five minutes, but this is an example only. In this embodiment, memory 116 saves five minutes of live video stream 122 before beginning overwriting. The predetermined amount of time can be less than five minutes, say 60 seconds or 45 seconds, for example, or can be more than five minutes, depending on the memory capability of memory 116 and the design of camera system 110.

When video camera 112 receives a capture command 136, which can be received from capture button 132 on video camera 112, video camera 112 transfers a second predetermined amount of time of stored live video stream 122 to memory 118 as a captured video clip 124. Video camera 112 continues to send live video stream 122 to first memory 116, which stores five minutes or the first predetermined amount of time of live video stream 122 and then overwrites itself.

Captured video clip 124 is stored in second memory 118. Captured video clip 124 can be transferred to other memory, sent to the internet, shared, or otherwise kept and used as needed. Captured video clip 124 includes the second predetermined amount of time of video that is less than the first predetermined amount of time of video that was stored before capture command 136 was received. The user of camera system 110 has the first predetermined amount of time to decide if they wish to keep any part or all of the first predetermined amount of time of live video stream 122. If the user of camera system 110 decides that video camera 112 captured something useful in the stored first predetermined amount of time of live video clip 122, the second predetermined amount of time of live video clip 22 stored can be converted to captured video clip 124 and saved for future use. For example, only and not by way of limitation, the first predetermined amount of time may be five minutes and the second predetermined amount of time may be one minute. Further, the camera may have a selection mechanism to adjust the second predetermined amount of time and further may include another selection mechanism to adjust the first predetermined amount of time. The adjustment of the second predetermined amount of time cannot exceed an amount of time longer than the first predetermined amount of time.

Camera system 110 can be integrated with geo-fenced areas like theme parks to capture and upload video of the theme park. Camera system 110 can be used at sporting events to store a video of important moments in the event. Camera system 110 can be used for public safety to retain a video of important events. Camera system 110 can be attached to a vehicle to capture events that occur in or near the vehicle. Camera system 110 can be used to capture many different types of events and occurrences.

Capture command 136 is generated by capture button 132 on video camera 112 in this embodiment, but this is not meant to be limiting. Capture command 136 can be generated by a user, by processor 134, remotely, or automatically. In some embodiments, camera system 110 is mounted to a vehicle and capture command 136 is generated in response to an impact or other traffic event. Capture command 136 can be generated by an app in a mobile computing device coupled to video camera 112. The capture button 132 may be an automatic button that includes a noise sensor, a motion sensor and the like in order to automatically initiate capture command 136. Capture command 136 can be generated in any number of ways.

Second memory 118 is communicatively coupled to video camera 112 via communication link 130. Communication link 130 can be wired or wireless. In this embodiment, second memory 118 is a part of video camera 112, and included in the housing of video camera 112, but this is not always the case. The second memory 118 may be a computer memory, cloud memory, a social media platform, a phone memory a tablet memory and the like. In the embodiment shown, second memory 118 is communicatively coupled to first memory 116. In some embodiments, second memory 118 is contained in a housing separate from video camera 112 and can be attached or mounted to video camera 112. In some embodiments, second memory 118 is a flash drive-type memory or other type of portable memory device that can be removably coupled to video camera 112.

Further still, the captured video clip 124 may be instantly broadcast out to others, such as through social media, by text, by streaming video to others, or other means of sharing video.

Video camera 112 is communicatively coupled to a mobile computing device 114 in this embodiment. Video camera 112 is communicatively coupled to mobile computing device 114 via communications link 140, which can be a wired or wireless communication link. Mobile computing device 114 in this embodiment is a smart phone, but can be any mobile computing device, such as a cellular phone, a computing tablet or pad, a mobile computer, or any other type of mobile computing device.

Mobile computing device 114 includes a camera app 120 that is used to control video camera 112. Camera app 120 can be used to send capture command 136, for example. Camera app 120 can be used to set up or control video camera 112 in many different ways.

Mobile computing device 114 includes a remote memory 138. In some embodiments, remote memory 138 is used instead of second memory 118. In some embodiments, video camera 112 transfers captured video clip 124 to both second memory 118 and remote memory 138.

Mobile computing device 114 is communicatively coupled to the internet 128 using a communication link 142, which can be a wired or a wireless communication link. Mobile computing device 114 transfers captured video clip 124 to internet 128 for many different purposes. Mobile computing device 114 can send captured video clip 124 to friends and family using social media through internet 128. This transfer can be programmed to occur automatically or manually. Mobile computing device 114 can send captured video clip 124 to cloud memory, to home or office computers, to security firms or police stations, to theme park offices, or any other device or computer accessed via internet 128. In other embodiments, the video camera 112 may bypass a mobile computing device 114 and the video camera 112 can automatically send captured video clip 124 to cloud memory, to home or office computers, to security firms or police stations, to theme park offices, or any other device or computer accessed via internet 128 when receiving a capture command 136.

Described is a camera system that continuously captures and stores a live video stream in a first memory. After a predetermined amount of time, the camera system overwrites the live video stream in the first memory. Within the predetermined amount of time, the user of the camera system can decide to save the live video of the previous predetermined amount of time, such as going back 15 seconds, 30 seconds, 60 seconds or more, in a second memory that is long-term storage. The camera can transfer a captured video clip from the first memory to the second memory. The captured video clip stored in the second memory can be used for security or recreational purposes. The camera system can be used in many different environments to conveniently and easily capture a long-term record of what the video camera recorded in its live video stream.

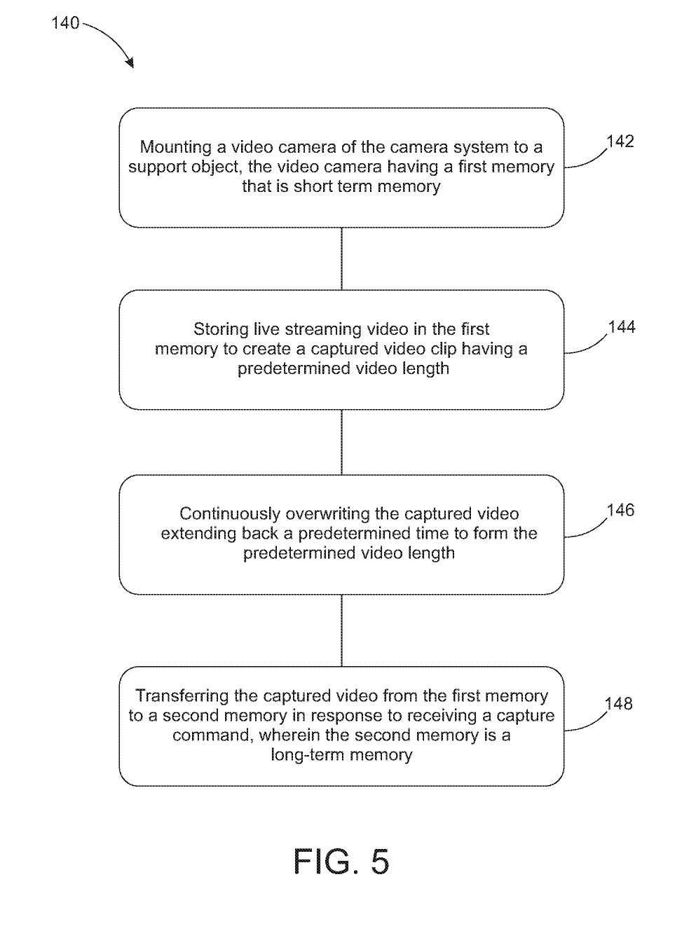

Embodiments may also include a method 140 of using a camera system, as depicted in FIG. 5. The method 140 may include mounting a video camera of the camera system to a support object, the video camera having a first memory (Step 142); storing a live video stream in the first memory, the stored live video stream having a first predetermined video length (Step 144); continuously overwriting the stored live video stream to ensure that the stored live video stream includes the most recent live streaming video extending back a predetermined time to form the first predetermined video length (Step 146); and transferring a captured video clip from the first memory to a second memory in response to receiving a capture command (Step 148), wherein the captured video clip is a portion of the stored live video stream having a second predetermined video length.

Step 142 of mounting the video camera to the support object may comprise mounting the video camera to one of a vehicle, a building, an article of furniture, a support device, a geological formation, a plant, an animal, or clothing of a person.

The method 140 may further comprise a step of generating the capture command in response to a user pressing a capture button of the camera system.

Embodiments may be available on or through the internet, such as through domain names reserved and owned by Applicant that include dontmissthemoment.com, nomissedmoment.com, youjustgotcammed.com, or the like.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A camera system comprising:
a video camera having an image sensor and a first memory, wherein the image sensor continuously sends a live video stream to store in the first memory while in operation;
a second memory communicatively coupled to the video camera, wherein the video camera sends a captured video clip to the second memory in response to receiving a capture command, the captured video clip formed from a portion of the live video stream stored in the first memory;
a venue having a geo-fence, wherein the captured video clip is automatically stored in the second memory in response to video captured within the geo-fence.

2. The camera system of claim 1, further comprising a processor coupled to the video camera and communicatively coupled to the image sensor and to the first memory.

3. The camera system of claim 2, wherein the live video stream continuously sent to the first memory by the image sensor continuously overwrites video images that were previously stored in the first memory after a first predetermined period of time of live video streaming is written to the first memory.

4. The camera system of claim 3, wherein the live video stream stored in the first memory at any moment is limited to a portion of the live video stream most recently sent to the first memory for a period of time substantially equal in duration to the first predetermined period of time.

5. The camera system of claim 1, further comprising a mobile computing device communicatively coupled to the video camera.

6. The camera system of claim 5, wherein the mobile computing device comprises a video camera app installed in a memory of the mobile computing device and operable on the mobile computing device.

7. The camera system of claim 6, wherein the video camera app operating on the mobile computing device provides a user interface for control of the video camera.

8. The camera system of claim 7, wherein the mobile computing device operating the video camera app operates the video camera to perform functions including sending the capture command to the video camera, and request transmission of the captured video clip from the second memory to the memory of the mobile computing device.

9. The camera system of claim 1, wherein the second memory is a flash memory removably coupled to the video camera.

10. The camera system of claim 1, wherein the video camera further comprises a capture button, wherein the capture command is generated in response to a user pressing the capture button.

11. The camera system of claim 10, wherein the capture button is coupled to a housing of the video camera and communicatively coupled to the processor.

12. The camera system of claim 1, wherein the capture command is generated by the processor in response to a motion captured by a video sensor.

13. The camera system of claim 1, further comprising a motion sensor coupled to the video camera and communicatively coupled to the processor, wherein the motion sensor sends a signal to the processor to generate a capture command in response to an impact of a support object with another object.

14. A camera system comprising:
a video camera having an image sensor, a first memory and a processor, wherein the image sensor continuously sends a live video stream to the first memory for storage while in operation and continuously overwrites the live video stream to maintain the live video stream at a first predetermined length of video;
a second memory communicatively coupled to the video camera, wherein the video camera sends a captured video clip to the second memory in response to receiving a capture command, wherein the captured video clip is a second predetermined length of video of the most recent live video stream, wherein the second predetermined length of video of the captured video clip is less than or equal to the first predetermined length of the live video stream; and
a venue having a geo-fence, wherein the second memory is a memory of the venue and the captured video clip is automatically stored in the memory of the venue in response to video captured within the geo-fence.

15. The camera system of claim 14, wherein the video camera further comprises a capture button, wherein the capture command is generated in response to a user pressing the capture button.

16. The camera system of claim 15, wherein the video camera is mounted to a support object.

17. The camera system of claim 16, wherein the support object is one of a vehicle, a building, an article of furniture, a support device, a geological formation, a plant, an animal, or clothing of a person.

18. A method of using a camera system, the method comprising:
mounting a video camera of the camera system to a support object, the video camera having a first memory;
storing a live video stream in the first memory, the stored live video stream having a first predetermined video length;
continuously overwriting the stored live video stream to ensure that the stored live video stream includes a most recent live streaming video extending back a predetermined time to form the first predetermined video length; and
transferring a captured video clip from the first memory to a second memory in response to receiving a capture command, wherein the captured video clip is a portion of the stored live video stream having a second predetermined video length, wherein the second memory is a memory of a venue having a geo-fence and the captured video clip is automatically stored in the memory of the venue in response to video captured within the geo-fence.

19. The method of claim 18, wherein mounting the video camera to the support object comprises mounting the video camera to one of a vehicle, a building, an article of furniture, a support device, a geological formation, a plant, an animal, or clothing of a person.

20. The method of claim 18, further comprising generating the capture command in response to a user pressing a capture button of the camera system.
